(19) United States
(12) Patent Application Publication
(10) Pub. No.: US 2026/0193757 A1
(43) Pub. Date: Jul. 9, 2026

(54) GRAIN ORIENTED ELECTRICAL STEEL SHEET AND METHOD OF MANUFACTURING SAME

(71) Applicant: POSCO CO., LTD, Pohang-si, Gyeongsangbuk-do (KR)

(72) Inventors: Kyungjun Ko, Pohang-si, Gyeongsangbuk-do (KR); Jaekyoum Kim, Pohang-si, Gyeongsangbuk-do (KR); IInam Yang, Pohang-si, Gyeongsangbuk-do (KR)

(73) Assignee: POSCO CO., LTD, Pohang-si, Gyeongsangbuk-do (KR)

(21) Appl. No.: 19/133,205

(22) PCT Filed: Dec. 13, 2023
(86) PCT No.: PCT/KR2023/020523

§ 371 Date: May 27, 2025

(30) Foreign Application Priority Data
Dec. 20, 2022 (KR) 10-2022-0179115

(51) Int. Cl. C22C 38/34; C21D 6/00; C21D 8/1216; C21D 8/1244; C21D 9/46; C22C 38/00; C22C 38/02; C22C 38/04; C22C 38/06; C22C 38/60; H01F 1/147

(52) U.S. Cl. CPC C22C 38/34; C21D 6/002; C21D 6/005; C21D 6/008; C21D 8/1222; C21D 8/1233; C21D 8/1261; C21D 8/1272; C21D 9/46; C22C 38/001; C22C 38/002; C22C 38/008; C22C 38/02; C22C 38/04; C22C 38/06; C22C 38/60; H01F 1/14775; C21D 2201/05; C22C 2202/02

(57) ABSTRACT

A grain-oriented electrical steel sheet according to an embodiment of the present disclosure includes a grain having an orientation of {110}<001>. A size of the grain satisfies Equation 1 below and an area fraction of the grain in which an angle deviated from the orientation of {110}<001> is within 3° is 60% or more.

$$W / L \leq 1.5 . \qquad 〈 Equation 1 〉$$

In Equation 1 above, W means a diameter in a transverse direction that is a width direction of a secondary recrystallization grain and L means a diameter in a rolling direction that is a length direction of the secondary recrystallization grain.

### TECHNICAL FIELD

The present disclosure relates to a grain-oriented electrical steel sheet and a method of manufacturing the same. More specifically, the present disclosure relates to a grain-oriented electrical steel sheet having an excellent magnetic characteristic and a small deviation in a characteristic within a coil through refinement of secondary recrystallization, and a method of manufacturing the same.

### BACKGROUND ART

An electrical steel sheet is a product used as a material for a transformer, a motor, and an electrical device, and unlike a general carbon steel that emphasizes processability such as a mechanical characteristic, the electrical steel sheet is a functional product that emphasizes an electrical characteristic. The electrical characteristic includes a characteristic such as iron loss, magnetic flux density, permeability, or a space factor, and the electrical steel sheet has low iron loss, high magnetic flux density, high permeability, and a high space factor. The electrical steel sheet is largely classified into a grain-oriented electrical steel sheet and a non-oriented electrical steel sheet. The grain-oriented electrical steel sheet is an electrical steel sheet with an excellent magnetic characteristic in a rolling direction by forming Goos texture ({110}<001> texture) throughout the steel sheet using an abnormal grain growth phenomenon called secondary recrystallization. The non-oriented electrical steel sheet is an electrical steel sheet in which a magnetic characteristic is uniform in all directions on a rolled sheet. The grain-oriented electrical steel sheet may be obtained by precisely arranging an orientation of a crystal grain in an orientation of {110}<001> in order to obtain high magnetic flux density. The electrical steel sheet with high magnetic flux density may reduce a size of an iron core material of the electrical device, and hysteresis loss of the electrical steel sheet may be lowered so that the electrical steel sheet miniaturizes the electrical device and simultaneously achieves high efficiency. The iron loss is electrical power loss consumed as heat energy when an arbitrary alternating magnetic field is applied to the steel sheet. The higher the magnetic flux density and resistivity, the lower the iron loss, and the lower a thickness of the sheet and a content of impurities in the steel sheet, the lower the iron loss, so that efficiency of the electrical device is increased. In order to globally prepare for a carbon-neutral era, an industrial structure is being reorganized into an eco-friendly low carbon industry so that a trend toward energy conservation and high-efficiency commercialization is spreading. According to the trend, social demand for the grain-oriented electrical steel sheet with a superior low iron loss characteristic is increasing as demand for supply of a high-efficiency electrical device that uses less electric energy increases. Therefore, a lot of research and development have been conducted so far to reduce the iron loss of the grain-oriented electrical steel sheet. A technology for refining a secondary recrystallization grain is attracting attention as one of effective methods for reducing the iron loss. The technology for refining the secondary recrystallization grain may decrease a magnetic domain in the steel sheet, and may reduce heat loss due to an eddy current accompanying a movement of a magnetic wall when the steel sheet is excited. In order to refine the secondary recrystallization grain, a Goss structure should be strongly developed during a process. A method of developing the Goss structure is a method of strongly providing deformation during hot rolling. The method for imparting strong deformation includes a rigid plastic method such as asymmetric rolling, equal channel angular extrusion (ECAP), or high pressure torsion (HPT). However, the method has not yet been industrially implemented. Another method for refining the secondary recrystallization grain is a method for minimizing a temperature deviation within a coil in a high-temperature annealing step in which the Goss structure grows. In general, the high-temperature annealing is performed in a batch form, and in this case, a temperature deviation of about 300° C. occurs in the coil so that a growth speed of the Goss structure varies depending on a position. Specifically, a gradient of the growth is formed from a high temperature to a low temperature so that there is a problem in which the Goss structure grows larger. Asymmetric growth of the Goss structure causes a deviation in the magnetic characteristic so that there is a problem that leads to an unexpected deterioration of a characteristic of the transformer.

### DISCLOSURE

### Technical Problem

A technical problem to be solved by the present disclosure provides a grain-oriented electrical steel sheet having an excellent magnetic characteristic and a small deviation in a characteristic within a coil by refining secondary recrystallization.

Another technical problem to be solved by the present disclosure provides a method of manufacturing the grain-oriented electrical steel sheet having the above-described advantage.

### Technical Solution

A grain-oriented electrical steel sheet according to an embodiment of the present disclosure includes: a grain having an orientation of {110}<001>. A size of the grain satisfies Equation 1 below and an area fraction of the grain in which an angle deviated from the orientation of {110}<001> is within 3° is 60% or more.

$$W / L \leq 1.5 . \qquad 〈 Equation 1 〉$$

In Equation 1 above, W means a diameter in a transverse direction that is a width direction of a secondary recrystallization grain and L means a diameter in a rolling direction that is a length direction of the secondary recrystallization grain.

The grain-oriented electrical steel sheet may satisfy Equation 2 below.

$$α \times β \times γ \leq 20 ° . \qquad 〈 Equation 2 〉$$

in Equation 2 above, α may mean an angular difference between the orientation of {110}<001> and a normal direction axis, β may mean an angular difference between the orientation of {110}<001> and a transverse direction axis, and γ may mean an angular difference between the orientation of {110}<001> and a rolling direction axis.

The grain-oriented electrical steel sheet may include, in wt %, Si: 2.0 to 5.0 wt %, C: 0.005 wt % or less, Mn: 0.03 to 0.5 wt %, Al: 0.01 to 0.04 wt %, and N: 0.002 to 0.005 wt %, may further include at least one of Sb: 0.01 to 0.05 wt %, Sn: 0.03 to 0.08 wt %, Cr: 0.01 to 0.2 wt %, S: 0.01 wt % or less, and P: 0.005 to 0.045 wt %, and may include the balance of Fe and an inevitable impurity.

A method of manufacturing the grain-oriented electrical steel sheet according to an embodiment of the present disclosure includes: hot-rolling a slab to manufacture a hot-rolled steel sheet; pre-rolling the hot-rolled steel sheet at a reduction ratio of 10 to 40% to manufacture a pre-rolled steel sheet; annealing the pre-rolled steel sheet; cold-rolling the annealed pre-rolled steel sheet to manufacture a cold-rolled steel sheet; performing primary recrystallization annealing on the cold-rolled steel sheet; and performing secondary recrystallization annealing on the annealed cold-rolled steel sheet. The hot-rolling of the slab includes winding the slab, a temperature of the winding is 600 to 800° C. in the winding of the slab, a temperature raising speed of secondary recrystallization is performed at a temperature range of 1000 to 1200° C. at 3 to 6° C./hr and a lower direct heating method is used in the performing of the secondary recrystallization annealing on the annealed cold-rolled steel sheet, and a size of a grain of the grain-oriented electrical steel sheet having an orientation of {110}<001> satisfies Equation 1 below and an area fraction of the grain in which an angle deviated from the orientation of {110}<001> is within 3° is 60% or more in a secondary recrystallization grain according to the secondary recrystallization annealing.

$$W / L \leq 1.5 . \qquad 〈 Equation 1 〉$$

In Equation 1 above, W means a diameter in a transverse direction that is a width direction of the secondary recrystallization grain and L means a diameter in a rolling direction that is a length direction of the secondary recrystallization grain.

A temperature of the steel sheet immediately before the pre-rolling may be 0.4 Tc to 0.6 Tc° C. in the manufacturing of the pre-rolled steel sheet, and Tc may refer to a winding temperature.

The method of manufacturing the grain-oriented electrical steel sheet may satisfy Equation 2 below.

$$100 \leq {T}_{b} - {T}_{a} \leq 300. \qquad 〈 Equation 2 〉$$

In Equation 2 above, Tₐ may mean a temperature at which the cold rolling is performed, and T_{b} may mean a temperature at which the pre-rolling is performed.

The manufacturing of the hot-rolled steel sheet may include rough rolling, finish rolling, and winding. A thickness of the pre-rolled steel sheet may be 1.5 to 3.0 mm.

The annealing of the pre-rolled steel sheet may be performed at a cracking temperature range of 700 to 1,100° C. In the manufacturing of the cold-rolled steel sheet, the reduction ratio may be 85 to 95%. A temperature of the steel sheet immediately before the cold rolling may be 0.2 Tc to 0.4 Tc° C. in the manufacturing of the cold-rolled steel sheet, and Tc may refer to a winding temperature.

### Advantageous Effects

A grain-oriented electrical steel sheet according to an embodiment of the present disclosure may provide a steel sheet having an excellent magnetic characteristic and a small deviation in a characteristic within a coil through refinement of secondary recrystallization by controlling a hot rolling condition and using pre-rolling.

A method of manufacturing the grain-oriented electrical steel sheet according to an embodiment of the present disclosure may provide a grain-oriented electrical steel sheet having the above-described advantage.

### MODE FOR INVENTION

When it is said that a portion is “on” or “above” another portion, the portion may be disposed directly on or above the other portion, or another portion may be interposed therebetween. In contrast, when a portion is said to be “directly above” another portion, no other portion is interposed therebetween.

Although not otherwise defined, all terms used herein, including a technical term and a scientific term, have the same meanings as those generally understood by a person of ordinary skill in the art to which the present disclosure belongs. Terms defined in a dictionary commonly used are additionally interpreted to have a meaning consistent with the relevant technical literature and the presently disclosed contents, and are not interpreted in an ideal or very formal sense unless otherwise defined.

Unless otherwise stated, % may mean wt %, and 1 ppm is 0.0001 wt %. In an embodiment of the present disclosure, inclusion of an additional element may mean replacing the balance of iron (Fe) by an additional amount of the additional element.

In the present disclosure, a Goss orientation is an orientation corresponding to {110}<001> in a Miller index.

Hereinafter, an embodiment of the present disclosure will be described in detail so that a person of ordinary skill in the art to which the present disclosure belongs may easily implement the present disclosure. The present disclosure may be modified in various ways, all without departing from the spirit or scope of the present disclosure.

A grain-oriented electrical steel sheet according to an embodiment of the present disclosure may include, in wt %, Si: 0.1 to 6.5 wt %, Al: 0.001 to 6.5 wt %, Mn: 0.01 to 20 wt %, C: 0.0050 wt % or less, and at least one of N, S, and Ti: 0.0003 to 0.001 wt %, and may include the balance of Fe and an inevitable impurity.

Hereinafter, a reason for limiting the components of the non-oriented electrical steel sheet will be described.

### Si: 2.0 to 5.0 wt %

Silicon (Si) may play a role in lowering iron loss by increasing resistivity of a material, and may be a component used as a deoxidizer in a steelmaking process. A content of the silicon may be 2.0 to 5.0 wt %. For example, the content of the silicon may be 3.0 to 4.5 wt %. The content of the silicon may satisfy the range so that an excellent magnetic characteristic and excellent productivity of the electrical steel sheet are secured.

If the content of the silicon is excessively high, ductility and toughness among mechanical characteristics may be reduced so that there is a problem in which sheet breakage frequently occurs in a rolling process and there is a problem in which the productivity is deteriorated due to a decrease in weldability between sheets in continuous annealing for commercial production. If the content of the silicon is excessively low, there may be a problem in which the resistivity is reduced and eddy current loss is increased so that an iron loss characteristic is degraded.

### C: 0.005 wt % or Less

Carbon (C) may be an austenite-stabilizing element, may be added to a slab to refine a coarse columnar structure generated during a continuous casting process, and may suppress slab center segregation of sulfur(S). In addition, the carbon (C) may promote processing hardening of the steel sheet during cold rolling to promote formation of a secondary recrystallization nucleus in an orientation of {110}<001> within the steel sheet. In the slab, a content of the carbon may be 0.01 to 0.10 wt %. For example, the content of the carbon may be 0.03 to 0.08 wt %.

If the content of the carbon is excessively high, an edge crack may occur during hot rolling.

However, the content of the carbon may be decreased during a decarbonization process, and if a large amount of the carbon remains in a finally manufactured grain-oriented electrical steel sheet, carbide formed due to a magnetic aging effect may be precipitated within the steel sheet so that the carbon deteriorates a magnetic characteristic. Therefore, after completion of high-temperature annealing, the content of the carbon in the finally manufactured grain-oriented electrical steel sheet may be 0.005 wt % or less or 0.003 wt % or less.

### Mn: 0.03 to 0.50 wt %

Manganese (Mn) may have an effect of reducing iron loss by increasing resistivity like Si to reduce eddy current loss. In addition, the manganese (Mn) may react with sulfur(S) present in the steel to form a manganese-based compound or may react with aluminum (Al) and nitrogen (N) to form nitride in a form of (Al, Si, Mn) N. Thus, the manganese (Mn) may play a role in forming a grain growth inhibitor. A content of the manganese may be 0.03 to 0.5 wt %. For example, the content of the manganese may be 0.05 to 0.3 wt %.

If the content of the manganese is excessively high, growth of a Goss structure during annealing of secondary recrystallization may be severely suppressed so that the magnetic characteristic is rapidly reduced. If the content of the manganese is excessively low, there may be a problem in which the above effect may not be expected.

### Al: 0.01 to 0.04 wt %

Aluminum (Al) not only may form nitride in a form of aluminum nitride (AlN) by being combined with a nitrogen ion introduced by an ammonia gas that is an atmospheric gas during nitriding in a primary recrystallization annealing process, but also may form nitride in a form of (Al, Si, Mn) N by being combined with silicon, manganese, and nitrogen that exist in a solid-solution state in the steel. Thus, the aluminum (Al) may play a role in forming a grain growth inhibitor. A content of the aluminum may be 0.01 to 0.04 wt %. For example, the content of the aluminum may be 0.015 to 0.035 wt %.

### N: 0.002 to 0.005 wt %

Nitrogen (N) may be an element that reacts with aluminum (Al) and manganese (Mn) to form compounds such as aluminum nitride (AlN) and (Al, Mn, Si) N. A content of the nitrogen may be 0.002 to 0.005 wt %. In addition, the nitrogen may be reinforced by nitriding treatment so that a nitrogen ion is diffused into the steel by introducing an ammonia gas as an atmospheric gas during a decarbonization annealing process to reinforce nitride for formation of secondary recrystallization of the Goss texture.

If the content of the nitrogen is out of an upper limit value of the range, a surface defect such as blister due to diffusion of nitrogen may be caused in a process after the hot rolling, and excessive nitride may be formed in a slab state so that there is a problem in which non-uniformity of a size of a grain of each of a hot-rolled annealing sheet and the primary recrystallization annealing sheet is increased. If the content of the nitrogen is out of a lower limit value of the range, there may be a problem in which an amount of an aluminum compound generated during the hot rolling is excessively small so that it is difficult to control a structure of the hot-rolled annealing sheet.

### Sb: 0.01 to 0.05 wt %

Antimony (Sb) may have an effect of inhibiting growth of the grain by segregating at a grain boundary and stabilizing the secondary recrystallization. However, because the antimony (Sb) has a low melting point, the antimony (Sb) may easily diffuse to a surface thereof during the primary recrystallization annealing to play a role in preventing decarbonization, formation of an oxide layer, and immersion due to nitriding. A content of the antimony may be 0.01 to 0.05 wt %. For example, the content of the antimony may be 0.02 to 0.04 wt %.

If the content of the antimony is excessively high, there may be a problem of hindering decarbonization and suppressing formation of an oxide layer that is a base coating. If the content of the antimony is excessively low, there may be a problem in which an effect of inhibiting growth of the grain is inferior.

### Sn: 0.03 to 0.08 wt %

Tin (Sn) may serve as a grain growth inhibitor because it is an element that interferes with movement of a grain boundary as a grain boundary segregation element. Grain growth inhibitory power for smooth secondary recrystallization behavior may be insufficient during the secondary recrystallization annealing in the above-described content range of the silicon, so that the tin that prevents movement of the grain boundary by segregating at the grain boundary is further added.

### Cr: 0.01 to 0.20 wt %

Chromium (Cr) may promote formation of a crystalline phase within an annealing sheet of a hot-rolled steel sheet, may promote formation of {110}<001> texture during cold rolling, and may promote decarbonization of carbon during the primary recrystallization annealing process. Thus, the chromium (Cr) may reduce a maintenance time of austenite phase transformation so that the texture is prevented from being damaged. In addition, the chromium may promote formation of an oxide layer on a surface formed during the primary recrystallization annealing process to solve a disadvantage of inhibiting formation of the oxide layer due to antimony and tin among an alloy element used as a grain growth aid inhibitor. A content of the chromium may be 0.01 to 0.20 wt %. For example, the content of the chromium may be 0.02 to 0.1 wt %.

### S: 0.01 wt % or Less

Sulfur(S) may be managed to maintain a low content because it deteriorates the magnetic characteristic and deteriorates heat processability by forming manganese sulfide (MnS) that is a fine precipitate. A content of the sulfur may be 0.010 wt %. For example, the content of the sulfur may be 0.005 wt % or less or 0.004 wt % or less.

If the content of the sulfur is excessively high, precipitates of the manganese sulfide may be formed within the slab so that growth of a grain is inhibited, and there may be a problem in which it is difficult to control a microstructure in a subsequent process due to segregation of the sulfur in a central portion of the slab during casting.

### P: 0.005 to 0.045 wt %

Phosphorus (P) may play an auxiliary role by segregating at the grain boundary to hinder movement of the grain boundary and simultaneously suppressing growth of the grain, and may play a role in improving the {110}<001> texture in terms of a microstructure. A content of the phosphorus may be 0.005 to 0.045 wt %.

If the content of the phosphorus is excessively high, brittleness may increase so that rollability is significantly reduced. If the content of the phosphorus is excessively low, there may be a problem in which an effect of addition is not confirmed.

The grain-oriented electrical steel sheet according to an embodiment of the present disclosure may include the balance of Fe and an inevitable impurity. The inevitable impurity may be an impurity mixed in a steelmaking step and a manufacturing process of the grain-oriented electrical steel sheet, and because this is widely known in the field, a detailed description thereof is omitted. In an embodiment of the present disclosure, addition of an element in addition to the alloy component described above is not excluded, and the element may be variously included within a range that does not impair the technical spirit of the present disclosure. If the additional element is further included, the balance of Fe may replace the balance of Fe.

The grain-oriented electrical steel sheet according to an embodiment of the present disclosure having the composition described above may have the following physical characteristic.

In the grain-oriented electrical steel sheet according to an embodiment, a size of a grain having the orientation of {110}<001> may satisfy Equation 1 below.

$$W / L \leq 1.5 . \qquad 〈 Equation 1 〉$$

In Equation 1 above, W may be a diameter in a TD direction (e.g., a width direction of a secondary recrystallization grain), and L may be a diameter in an RD direction (e.g., a length direction of the secondary recrystallization grain).

In Equation 1 above, W may represent a particle diameter of the secondary recrystallization grain in the width direction of the secondary recrystallization grain (e.g., a particle diameter of the secondary recrystallization grain having an orientation of the Goss texture that is the orientation of {110}<001>). The particle diameter of the secondary recrystallization grain may refer to the diameter of the secondary recrystallization grain measured on a surface (ND) perpendicular to a rolling surface (RD) after a secondary recrystallization annealing step is completed.

A size of the grain may mean a diameter of the grain, and the diameter of the grain may indicate a diameter of each grain as an equivalent circle diameter (ECD) corresponding to an area of each grain closed by the grain boundary in a structure photograph of a microscope. In this case, distribution of diameters of grains may be obtained using the ECD, and an average diameter of the grain may be calculated by taking an arithmetic average thereof.

A value of Equation 1 above may be less than or equal to 1.5. For example, the value of Equation 1 above may be 0.7 to 1.5 or less. For example, the value of Equation 1 above may be 0.9 to 1.5 or less. Because the value of Equation 1 above satisfies the above-described range, a thermal gradient may be reduced during a secondary recrystallization annealing process so that a degree of integration of the Goss structure is improved.

In an embodiment, the width direction of the secondary recrystallization grain may be in a range of 10 to 150 mm. For example, the width direction of the secondary recrystallization grain may be in a range of 15 to 100 mm.

If the width direction of the secondary recrystallization grain is out of an upper limit value of the range, there may be a problem of lowering the degree of integration of the Goss structure. If the width direction of the secondary recrystallization grain is out of a lower limit value of the range, there may be a problem of deterioration of iron loss due to a decrease in the degree of integration and an increase in eddy current loss.

In an embodiment, the length direction of the secondary recrystallization grain may be in a range of 10 to 100 mm. For example, the length direction of the secondary recrystallization grain may be in a range of 15 to 75 mm.

If the length direction of the secondary recrystallization grain is out of an upper limit value of the range, there may be a problem of lowering the degree of integration of the Goss structure. If the length direction of the secondary recrystallization grain is out of a lower limit value of the range, there may be a problem of deterioration of the iron loss due to a decrease in the degree of integration and an increase in the eddy current loss.

In an embodiment, the grain-oriented electrical steel sheet may satisfy Equation 2 below.

$$α \times β \times γ \leq 20 ° . \qquad 〈 Equation 2 〉$$

In Equation 2 above, α may mean an angular difference between the orientation of {110}<001> and an ND axis, β may mean an angular difference between the orientation of {110}<001> and a TD axis, and γ may mean an angular difference between the orientation of {110}<001> and an RD axis.

A degree of integration of the Goss texture having the orientation of {110}<001> of the secondary recrystallization grain may be confirmed by a misalignment angle of an orientation of the secondary recrystallization grain from the orientation of the Goss texture. For example, the misalignment angle may evaluate a degree of integration for three rotation axes. For example, the three rotation axes may be distinguished by misalignment angles with respect to a normal direction (ND) axis, a transverse direction (TD) axis, and a rolling direction (RD) axis.

Based on the above-described misalignment angle, in Equation 2 above, a may mean an angular difference between the orientation of the Goss texture and the normal direction axis of the rolling surface, β may mean an angular difference between the orientation of the Goss texture and the transverse direction (TD) axis, and γ may mean an angular difference between the orientation of the Goss texture and the rolling direction axis.

In an embodiment, the above-described α×β×γ value may be less than or equal to 20°. For example, the value may be 10° to 18° or less. By satisfying the value, there is an advantage that the degree of integration of the Goss structure is excellent.

In an embodiment, it may be important for the grain-oriented electrical steel sheet to be aligned with <001> in the rolling direction that is an easy axis of magnetization, and an area fraction of the grain in which an angle deviated from the orientation of <001> is within 3° may be 60% or more. For example, the area fraction of the grain in which the angle deviated from the orientation of <001> is within 3° may be 65 to 75%.

Because the area fraction of the grain in which the angle deviated from the orientation of <001> is within 3° falls within the above-described range, there may be an advantage in that magnetization of the grain-oriented electrical steel sheet is facilitated. If the area fraction of the grain in which the angle deviated from the orientation of <001> is within 3° is out of the above-described range, there may be a problem in which magnetization is not easily performed.

A method of manufacturing the grain-oriented electrical steel sheet according to an embodiment of the present disclosure may include a step of hot-rolling the slab to manufacture the hot-rolled steel sheet, a step of pre-rolling the hot-rolled steel sheet to manufacture a pre-rolled steel sheet, a step of annealing the pre-rolled steel sheet, a step of cold-rolling the annealed pre-rolled steel sheet to manufacture a cold-rolled steel sheet, a step of performing primary recrystallization annealing on the cold-rolled steel sheet, and a step of performing secondary recrystallization annealing on the annealed cold-rolled steel sheet.

First, the hot-rolled steel sheet may be manufactured by hot-rolling the slab. Because an alloy composition of the slab is described in relation to an alloy composition of the grain-oriented electrical steel, a redundant description thereof will be omitted. For example, the slab may include, in wt %, Si: 0.1 to 6.5 wt %, Al: 0.001 to 6.5 wt %, Mn: 0.01 to 20 wt %, C: 0.0010 to 0.0150 wt %, and at least one of N, S, and Ti: 0.0003 to 0.001 wt %, and may include the balance of Fe and an inevitable impurity.

Returning to the description of the manufacturing method, in an embodiment, the step of hot-rolling the slab to manufacture the hot-rolled steel sheet may include a step of heating the slab. For example, the slab may be heated to 1250° C. or less. A precipitate of aluminum-based nitride or a precipitate of manganese-based sulfide may be incompletely dissolved or completely dissolved according to a stoichiometric relationship between aluminum (Al) and nitrogen (N) dissolved due to the heating and a stoichiometric relationship between manganese (Mn) and sulfur(S) dissolved due to the heating.

In an embodiment, the slab may be hot-rolled to manufacture the hot-rolled steel sheet.

In an embodiment, the step of hot-rolling the slab to manufacture the hot-rolled steel sheet may include a step of rough rolling the slab, a step of finish rolling the slab, and a step of winding the slab. For example, the step of rough rolling the slab, the step of finish rolling the slab, and the step of winding the slab may be sequentially performed.

In an embodiment, the step of rough rolling the slab may roll the heated slab to a thickness of 50 to 70 mm. In an embodiment, the step of rough rolling the slab may be performed at a temperature range of 950 to 1,100° C.

In an embodiment, the step of finish rolling the slab may roll the rough-rolled slab to a thickness of 2.0 to 4.0 mm. In an embodiment, the step of finish rolling the slab may be performed at a temperature range of 800 to 1,000° C.

In an embodiment, the hot-rolled steel sheet undergoing the step of finish rolling the slab may be wound. In an embodiment, the winding step may be performed at a temperature range of 600 to 800° C. For example, the temperature range may be performed in a temperature range of 650 to 750° C.

If the temperature is out of an upper limit value of the temperature range, a fraction of the Goss grain may be increased after annealing, but a crack of an edge portion of a side surface of the steel sheet may be increased so that productivity is degraded, and there may be a problem in which a precipitate and microstructure become coarse so that good and stable magnetism may not be obtained. If the temperature is out of a lower limit value of the temperature range, there may be a problem in which a precipitate and a surface grain are fine so that an effect of increasing a fraction of the Goss texture after the pre-rolling step and the step of annealing the pre-rolled steel sheet is reduced.

In an embodiment, a thickness of the hot-rolled steel sheet may be 1.0 to 4.0 mm. For example, the thickness of the hot-rolled steel sheet may be 1.5 to 3.0 mm.

In an embodiment, the step of pre-rolling the hot-rolled steel sheet to manufacture the pre-rolled steel sheet may be a step of further increasing the fraction of the Goss structure after the annealing by further rolling the hot-rolled steel sheet undergoing the winding step. The Goss structure may grow in the primary recrystallization annealing step and the secondary recrystallization annealing step described below so that an orientation of the secondary recrystallization in a finally manufactured grain-oriented electrical steel sheet may be disposed more accurately.

In an embodiment, the pre-rolling step may be performed at a temperature at which a temperature of the steel sheet immediately before the pre-rolling is within a range of 0.4 Tc to 0.6 Tc° C. The Tc may refer to a winding temperature [° C.]. If the temperature is out of an upper limit value of the temperature of the steel sheet, a fraction of the Goss grain may be increased but there may be a problem of productivity and temperature control, and if the temperature is out of a lower limit value of the temperature of the steel sheet, there may be a problem in which it is difficult to obtain an effect of the pre-rolling. For example, the pre-rolling step may be performed at a temperature range of 260 to 450° C. or 300 to 400° C. of the steel sheet immediately before the pre-rolling.

In an embodiment, the pre-rolling step may be performed at a reduction ratio of 10 to 40%. For example, the reduction ratio may be 15 to 35%. In some embodiments, the reduction ratio may be 20 to 30%.

If the reduction ratio is out of the upper limit value, a fraction of the Goss grain may be increased after annealing, but there may be a problem in which a crack of an edge portion of a side surface of the steel sheet may be increased so that productivity is degraded. If the reduction ratio is out of the lower limit value, there may be a problem in which it is difficult to obtain an effect of the pre-rolling.

The pre-rolling step may be performed once or multiple times, and a thickness of the pre-rolled steel sheet undergoing the pre-rolling step may be 1.5 to 3.0 mm.

In an embodiment, the step of annealing the pre-rolled steel sheet may be performed at a predetermined range of cracking temperature and a predetermined range of cracking time. In an embodiment, the step of annealing the pre-rolled steel sheet may be performed at a cracking temperature range of 800 to 1,100° C. In an embodiment, the step of annealing the pre-rolled steel sheet may be performed at a cracking time range of 100 to 300 seconds.

It may be confirmed that the fraction of the Goss grain is increased through the step of manufacturing the pre-rolled steel sheet and the step of annealing the pre-rolled steel sheet. For example, a volume fraction of a grain forming an angle of 15° or less with the Goss structure among grains of the pre-rolled steel sheet annealed after the step of annealing the pre-rolled steel sheet may increase to 4 to 10% within the above-described reduction ratio.

The step of cold-rolling the annealed pre-rolled steel sheet to manufacture the cold-rolled steel sheet may perform one cold rolling or two or more cold rollings including intermediate annealing. In an embodiment, the step of cold-rolling the annealed pre-rolled steel sheet to manufacture the cold-rolled steel sheet may be performed at a reduction ratio of 85 to 95%.

If the reduction ratio is out of the upper limit value, there may be a problem in which the fraction of the Goss structure of the grain generated after primary annealing may decrease so that magnetism is deteriorated. If the reduction ratio is out of the lower limit value, an appropriate thickness of the steel sheet may not be secured, or the reduction ratio has to be increased in the hot-rolling step and the pre-rolling step and productivity and magnetism may be degraded. The cold rolling may be performed within the above-described reduction ratio range so that the cold-rolled steel sheet is manufactured to have a thickness of 0.1 to 0.3 mm.

In an embodiment, the step of cold-rolling the annealed pre-rolled steel sheet to manufacture the cold-rolled steel sheet may roll the steel sheet having a temperature of 0.2 Tc to 0.4 Tc° C. immediately before the rolling. The Tc may refer to a winding temperature [° C.]. If the temperature of the steel sheet is out of the upper limit value, a fraction of the Goss grain may be decreased, and if the temperature of the steel sheet is out of the lower limit value, there may be a problem in which it is difficult to obtain an effect of the pre-rolling. For example, the step of cold-rolling the annealed pre-rolled steel sheet to manufacture the cold-rolled steel sheet may be performed at 130 to 300° C. or 150 to 200° C.

In an embodiment, the method of manufacturing the grain-oriented electrical steel sheet may satisfy Equation 3 below.

$$100 \leq {T}_{b} - {T}_{a} \leq 300. \qquad 〈 Equation 3 〉$$

In Equation 3 above, Tₐ may mean a temperature at which the cold rolling is performed, and T_{b} may mean a temperature at which the pre-rolling is performed.

In an embodiment, in the step of performing the primary recrystallization annealing on the cold-rolled steel sheet, the primary recrystallization in which a nucleus of the Goss grain is generated may occur. The primary recrystallization annealing step may include a step of decarbonizing and nitriding the cold-rolled steel sheet.

In an embodiment, the step of performing the primary recrystallization annealing on the cold-rolled steel sheet may be performed at a temperature range of 800 to 950° C. for the decarbonization. If the temperature is out of an upper limit value of the temperature range, there may be a problem in which recrystallization grains coarsely grow so that a growth driving force of the grain is degraded and stable secondary recrystallization grain is not formed.

In an embodiment, the step of performing the primary recrystallization annealing on the cold-rolled steel sheet may be performed at a dew point temperature of 50 to 70° C. for the decarbonization. In an embodiment, the primary recrystallization annealing step may be performed within 5 minutes.

In an embodiment, the step of performing the primary recrystallization annealing on the cold-rolled steel sheet may include a step of decarbonizing and nitriding the cold-rolled steel sheet. The decarbonizing step and the nitriding step may be performed regardless of an order. For example, the nitriding step may be performed after the decarbonization step, or the decarbonization step may be performed after the nitriding step.

In an embodiment, the method may include a step of performing the primary recrystallization by simultaneously performing decarbonization annealing and nitriding treatment on the cold-rolled steel sheet obtained through the cold rolling. For example, the decarbonization step and the nitriding step may be simultaneously performed.

In an embodiment, the decarbonization step may be performed in a hydrogen atmosphere, a nitrogen atmosphere, or a mixed gas atmosphere thereof. In the decarbonization step, C may be decarbonized to 0.005 wt % or less. For example, C may be decarbonized to 0.003 wt % or less.

The nitriding step may be a step for nitrification within the steel sheet, may be a step for introducing a nitrogen ion into the steel sheet, and may be a step for generating a precipitate such as (Al, Si, Mn) N or AlN that is a crystal growth inhibitor. Nitrification may be performed through the nitriding step so that nitrogen of the grain-oriented electrical steel sheet is 0.005% or less. For example, the nitriding step may be performed in an atmosphere including an ammonia gas.

In an embodiment, after the primary recrystallization annealing step, an annealing separator may be applied to the steel sheet. For example, the annealing separator may be an annealing separating agent including MgO as a primary component or an annealing separating agent including alumina as a primary component. Because the annealing separator is widely known, a detailed description thereof will be omitted.

In an embodiment, the step of performing the secondary recrystallization annealing on the annealed cold-rolled steel sheet may form the Goss texture by the secondary recrystallization, may impart insulation by forming a glassy coating by reaction of MgO with an oxide layer formed during the primary recrystallization annealing, and may remove an impurity that inhibits a magnetic characteristic.

In an embodiment, the secondary recrystallization annealing step may include a temperature raising step and a cracking step. For example, the secondary recrystallization annealing step may include a temperature raising step before the secondary recrystallization occurs. The temperature raising step may be maintained in nitrogen, hydrogen, or a mixed gas of the nitrogen and the hydrogen to protect nitride that is a particle growth inhibitor so that the secondary recrystallization develops well.

In an embodiment, in the secondary recrystallization annealing step, the temperature raising step may be performed at a temperature raising speed in a range of 3 to 6° C./hr.

If the temperature raising speed is out of an upper limit value of the temperature raising speed range, there may be a problem in which an effect of increasing a degree of integration of the Goss structure and an effect of reducing a temperature deviation of the steel sheet are not exerted. If the temperature raising speed is out of a lower limit value of the temperature raising speed range, there may be a problem of deterioration in productivity.

In an embodiment, the secondary recrystallization annealing step may include the cracking step after development of the secondary recrystallization is completed. For example, the cracking step may be maintained in a 100% hydrogen atmosphere for a long time to remove an impurity.

In an embodiment, the secondary recrystallization annealing step may be performed in a lower direct heating method. For example, for the secondary recrystallization annealing, a step of applying additional heat to a lower portion of a coil by a heating element (e.g., an electric resistance heating element) may be included.

The heating element may be disposed below the coil to increase an amount of heat flowing into a lower portion of the coil, so that a temperature deviation of the coil is reduced during heat treatment. The heating element may be controlled in the same way as a heat pattern of an annealing furnace, or may be controlled with a separate heat pattern.

The secondary recrystallization annealing step may be performed in one of a continuous annealing furnace and a batch annealing furnace. For example, the secondary recrystallization annealing step may be performed in the batch annealing furnace.

Hereinafter, a specific embodiment of the present disclosure will be described. However, the following embodiment is only the specific embodiment of the present disclosure, and the present disclosure is not limited to the following embodiment.

### Experimental Example 1

A steel slab that includes, in wt %, Si: 3.3%, C: 0.055%, Mn: 0.08%, Al: 0.029%, N: 0.004%, Sb: 0.02%, Sn: 0.05%, Cr: 0.09%, and P: 0.028%, and may include the balance of Fe and an inevitable impurity, is prepared. The steel slab is heated at 1,150° C., and then hot rolling and pre-rolling are performed on the heated steel slab to manufacture a hot-rolled steel sheet.

In this case, a thickness, a winding temperature, and a pre-rolling condition of the hot-rolled steel sheet are changed to various conditions as shown in Table 1 below.

The pre-rolled annealed sheet is cold-rolled to a thickness of 0.15 to 0.23 mm, and then primary recrystallization annealing is performed at a dew point temperature of 60° C. and a temperature of 850° C., and secondary recrystallization annealing is performed at a temperature raising speed of 3 to 6° C./hr and a temperature of 1200° C.

In this case, the condition is changed to various conditions depending on the temperature raising speed of the secondary recrystallization annealing and a condition of use of a lower heating element.

After a coating layer on a surface of the steel sheet is removed using a hydrochloric acid solution, the W/L ratio of the grain is measured, and an angle formed by the grain with the orientation of {110}<001> is measured using an X-Ray Laue analysis device.

In Table 1 below, a temperature of the pre-rolling may refer to a temperature of the steel sheet immediately before the pre-rolling step, and a temperature of the cold-rolling may refer to a temperature of the steel sheet immediately before the cold rolling.

TABLE 1

| | | | | | | Temperature | Whether | | | |
|---|---|---|---|---|---|---|---|---|---|---|
| | | | | | | raising | lower | RD/<100> | | |
| | | | Pre- | Temperature | Temperature | speed of | heating | fraction | | |
| | Thickness | Winding | rolling | pre- | of cold | secondary | element | within | | |
| | hot rolling | temperature | rate | rolling | rolling | recrystallization | is used | 3º | W/L | α×β×γ |
| Classification | [mm] | [°C] | [%] | [°C] | [°C] | [°C/hr] | [O/X] | (%) | — | [°] |
| Comparative | 2.3 | 650 | — | — | 150 | 4.2 | O | 48 | 1.8 | 24 |
| material 1 | | | | | | | | | | |
| Comparative | 2.5 | 650 | 8 | 350 | 200 | 6.8 | X | 36 | 2.1 | 27 |
| material 2 | | | | | | | | | | |
| Comparative | 2.7 | 700 | 14.8 | 400 | 250 | 5.3 | X | 33 | 1.7 | 30 |
| material 3 | | | | | | | | | | |
| Comparative | 3.1 | 750 | 25.8 | 300 | 150 | 6.8 | O | 52 | 1.8 | 22 |
| material 4 | | | | | | | | | | |
| Comparative | 3.4 | 750 | 32.4 | 350 | 200 | 4.9 | X | 35 | 2.0 | \|28 |
| material 5 | | | | | | | | | | |
| Comparative | 3.4 | 550 | 32.4 | 400 | 250 | 4.5 | O | 41 | 2.0 | 24 |
| material 6 | | | | | | | | | | |
| Embodiment | 3 | 650 | 23.3 | 300 | 150 | 4.3 | O | 65 | 1.2 | 18 |
| material 1 | | | | | | | | | | |
| Embodiment | 3.5 | 650 | 34.3 | 350 | 200 | 3.5 | O | 70 | 1.3 | 16 |
| material 2 | | | | | | | | | | |
| Embodiment | 3.8 | 650 | 39.5 | 300 | 150 | 5.1 | O | 70 | 1.0 | 14 |
| material 3 | | | | | | | | | | |
| Embodiment | 2.7 | 700 | 14.8 | 350 | 200 | 5.6 | O | 68 | 1.1 | 16 |
| material 4 | | | | | | | | | | |
| Embodiment | 3.1 | 700 | 25.8 | 400 | 150 | 6.0 | O | 65 | 1.1 | 15 |
| material 5 | | | | | | | | | | |
| Embodiment | 2.6 | 700 | 11.5 | 300 | 200 | 3.8 | O | 60 | 0.9 | 19 |
| material 6 | | | | | | | | | | |
| Embodiment | 2.7 | 750 | 25.8 | 300 | 150 | 4.6 | O | 64 | 1.2 | 18 |
| material 7 | | | | | | | | | | |
| Embodiment | 2.3 | 750 | 21.9 | 400 | 250 | 4.6 | O | 65 | 1.1 | 16 |
| material 8 | | | | | | | | | | |
| Embodiment | 2.1 | 750 | 28.4 | 400 | 150 | 5.2 | O | 75 | 1.4 | 13 |
| material 9 | | | | | | | | | | |

Referring to Table 1 above, it may be confirmed that the winding temperature is controlled within the scope of the present disclosure, the pre-rolling is performed after the hot rolling within the scope of the present disclosure, the temperature raising speed is performed during the secondary recrystallization within the scope of the present disclosure, and distribution of sizes of grains and the degree of integration of the Goss structure are improved because the lower heating element is used. The present disclosure is not limited to the embodiments and/or the examples, may be manufactured in various different forms, and a person of ordinary skill in the art to which the present disclosure belongs will be able to understand that the present disclosure may be implemented in other specific forms without changing the technical idea or essential feature of the present disclosure. Therefore, it should be understood that the embodiments and/or the examples described above are illustrative and not limited in all respects.

1. A grain-oriented electrical steel sheet, comprising a grain having an orientation of {110}<001>,
wherein a size of the grain satisfies Equation 1 below and an area fraction of the grain in which an angle deviated from the orientation of {110}<001> is within 3° is 60% or more:
$$W / L \leq 1.5 \qquad 〈 Equation 1 〉$$
wherein in Equation 1 above, W means a diameter in a transverse direction that is a width direction of a secondary recrystallization grain and L means a diameter in a rolling direction that is a length direction of the secondary recrystallization grain.

2. The grain-oriented electrical steel sheet of claim 1, wherein the grain-oriented electrical steel sheet satisfies Equation 2 below:
$$α \times β \times γ \leq 20 ° \qquad 〈 Equation 2 〉$$
wherein in Equation 2 above, α means an angular difference between the orientation of {110}<001> and a normal direction axis, β means an angular difference between the orientation of {110}<001> and a transverse direction axis, and γ means an angular difference between the orientation of {110}<001> and a rolling direction axis.

3. The grain-oriented electrical steel sheet of claim 1, wherein the grain-oriented electrical steel sheet includes, in wt %, Si: 2.0 to 5.0 wt %, C: 0.005 wt % or less, Mn: 0.03 to 0.5 wt %, Al: 0.01 to 0.04 wt %, and N: 0.002 to 0.005 wt %, further includes at least one of Sb: 0.01 to 0.05 wt %, Sn: 0.03 to 0.08 wt %, Cr: 0.01 to 0.2 wt %, S: 0.01 wt % or less, and P: 0.005 to 0.045 wt %, and includes the balance of Fe and an inevitable impurity.

4. A method of manufacturing a grain-oriented electrical steel sheet, comprising:
hot-rolling a slab to manufacture a hot-rolled steel sheet;
pre-rolling the hot-rolled steel sheet at a reduction ratio of 10 to 40% to manufacture a pre-rolled steel sheet;
annealing the pre-rolled steel sheet;
cold-rolling the annealed pre-rolled steel sheet to manufacture a cold-rolled steel sheet;
performing primary recrystallization annealing on the cold-rolled steel sheet; and
performing secondary recrystallization annealing on the annealed cold-rolled steel sheet,
wherein the hot-rolling of the slab includes winding the slab, a temperature of the winding is 600 to 800° C. in the winding of the slab, a temperature raising speed of secondary recrystallization is performed at a temperature range of 1000 to 1200° C. at 3 to 6° C./hr and a lower direct heating method is used in the performing of the secondary recrystallization annealing on the annealed cold-rolled steel sheet, and a size of a grain of the grain-oriented electrical steel sheet having an orientation of {110}<001> satisfies Equation 1 below and an area fraction of the grain in which an angle deviated from the orientation of {110}<001> is within 3° is 60% or more in a secondary recrystallization grain according to the secondary recrystallization annealing:
$$W / L \leq 1.5 \qquad 〈 Equation 1 〉$$
wherein in Equation 1 above, W means a diameter in a transverse direction that is a width direction of the secondary recrystallization grain and L means a diameter in a rolling direction that is a length direction of the secondary recrystallization grain.

5. The method of manufacturing the grain-oriented electrical steel sheet of claim 4, wherein a temperature of the steel sheet immediately before the pre-rolling is 0.4 Tc to 0.6 Tc° C. in the manufacturing of the pre-rolled steel sheet, and Tc refers to a winding temperature.

6. The method of manufacturing the grain-oriented electrical steel sheet of claim 4, wherein the method of manufacturing the grain-oriented electrical steel sheet satisfies Equation 2 below:
$$100 \leq {T}_{b} - {T}_{a} \leq 300 \qquad 〈 Equation 2 〉$$
wherein in Equation 2 above, Tₐ means a temperature at which the cold rolling is performed, and T_{b} means a temperature at which the pre-rolling is performed.

7. The method of manufacturing the grain-oriented electrical steel sheet of claim 4, wherein the manufacturing of the hot-rolled steel sheet includes rough rolling, finish rolling, and winding.

8. The method of manufacturing the grain-oriented electrical steel sheet of claim 4, wherein a thickness of the pre-rolled steel sheet is 1.5 to 3.0 mm.

9. The method of manufacturing the grain-oriented electrical steel sheet of claim 4, wherein the annealing of the pre-rolled steel sheet is performed at a cracking temperature range of 700 to 1,100° C.

10. The method of manufacturing the grain-oriented electrical steel sheet of claim 4, wherein in the manufacturing of the cold-rolled steel sheet, the reduction ratio is 85 to 95%.

11. The method of manufacturing the grain-oriented electrical steel sheet of claim 4, wherein a temperature of the steel sheet immediately before the cold rolling is 0.2 Tc to 0.4 Tc° C. in the manufacturing of the cold-rolled steel sheet, and Tc refers to a winding temperature.
